(19) United States
(12) Patent Application Publication
(10) Pub. No.: US 2004/0222299 A1
(43) Pub. Date: Nov. 11, 2004

(54) Indexer structure combined with a card-reading device

(76) Inventors: Potter Hsieh, Taipei (TW); Jason Chen, Taipei (TW)

Correspondence Address: Keith Kline, PRO-TECHTOR INTERNATIONAL SERVICES, 20775 Norada Court, Saratoga, CA, 95070-3018, US

(21) Appl. No.: 10/430,239

(22) Filed: May 5, 2003

(51) Int. Cl. G06K 7/00

(52) U.S. Cl. 235/439

(57) ABSTRACT

The present invention relates to an indexer structure combined with a card-reading device. The structure is made by combining an indexer and a card-reading device so as to form a unity. Therefore, the two separately operated structures are combined to be an indexer provided with a card-reading device. By inserting or closely inducing a card in a contact or non-contact mode, the combined structure not only has the function of an indexer, but also the functions of card-reading identification, accessing or security shelter. This omni-functional structure can be employed in different applications and promote the convenience of usage.

### BACKGROUND OF THE INVENTION

1. Field of the Invention

The present invention relates to an indexer structure combined with a card-reading device having the functions of selectively inputting message, card-reading identification, accessing data or security shelter. The structure is made by combining an indexer and a card-reading device so as to form a unity being an indexer provided with a card-reading device. By inserting or closely inducing a card in a contact or non-contact mode, the combined structure is designed to have the functions of an indexer and a card-reading device.

2. Description of the Prior Art

As the technology develops in a high speed, nowadays, the computer is required to be an auxiliary for an enterprise and is a necessary personal device. The peripheral devices of the computer also advance fast. For example, a keyboard or an indexer (such as a mouse, a digital board, a hand-writing input device) is commonly known as an input device of the computer. Generally, the indexer has a single function for inputting messages or executing commands. There are various kinds of peripheral devices for the computer. In addition to the mentioned devices being the most commonly used, a card-reading device is also popular and commonly used by a business or a person. The card-reading device provides the functions of data accessing, user identification or security shelter. Although the mentioned individual structure makes the usage convenient for the user, the user usually irked in the actual usage. This is because each of the structures is separately connected to the computer via a USB, PS2, or a serial port, and when more peripheral devices are used, the number of the required connecting ports is increased. The computer generally has a fixed number of the ports, and when additional ports are required, the user has to add the number of the ports by installing the outside connecting ports. This will increase the cost. In other words, in addition to employ an indexer for inputting, the user also has to buy a card-reading device when the applications of the user identification, the data reading or security protection are required. Furthermore, when the number of the connecting ports for the peripheral devices is not great enough, the user has to additionally install the outside-connecting expansion devices. This will increase the cost and the required space. In this technology field, many efforts are provided to efficiently resolve the mentioned problems. This makes a main stream for development and research.

In order to resolve the mention problems of the prior art, the present invention provides a combined structure of an indexer and a card-reading device. Originally, these two devices have independent structures, and in this invention they are combined to form a unity device for their common characteristic of being an input device. The inventive combined structure is called as an indexer structure combined with a card-reading device.

### SUMMARY OF THE INVENTION

The main object of the present invention is to provide an indexer structure combined with a card-reading device, made by combining an indexer and a card-reading device. The two devices are originally independent products, and they are combined to form a unity for their common characteristic of being an input device so as to make the user perform not only the functions of the indexer, such as selecting data point by point and executing command, but also the functions of the card-reading device, such as accessing the more important data or the greater amount of data from the IC card. This will make the cost reduced and promote the convenience of usage.

The another object of the invention is to provide an indexer structure combined with a card-reading device for connecting the card-reading device and the indexer to the computer via the same transmission interface (USB, PS2, or serial port) so as to reduce the occupied space.

The another object of the invention is to provide an indexer structure combined with a card-reading device for reading the data from the card via any appropriate position in the indexer structure by inserting or closely inducing the card in a contact or a non-contact way so as to performing the functions of reading, transmission or identification.

The main characteristic of the inventive indexer structure combined with a card-reading device is the structure is made by combining an indexer and a card-reading device so as to form a unity. In this way, the originally independent structures being operated separately are combined to be an indexer provided with a card-reading device. By the combination of the circuits, the card is inserted or closely induced in a contact or a non-contact mode, and the inventive structure not only can be operated as an indexer, but also has the functions of card-reading identification, accessing or security shelter. Therefore, the omni-functional structure according to the invention is designed for performing multiple functions and promoting the convenience of usage.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of an indexer structure combined with a card-reading device according to an embodiment of the present invention;

FIG. 2 is a perspective diagram of an indexer structure combined with a card-reading device according to another embodiment of the present invention; and

FIG. 3 is a block diagram of the circuit of the inventive indexer structure combined with a card-reading device.

### DETAILED DESCRIPTION OF THE PREFERRED EMBODIMENT

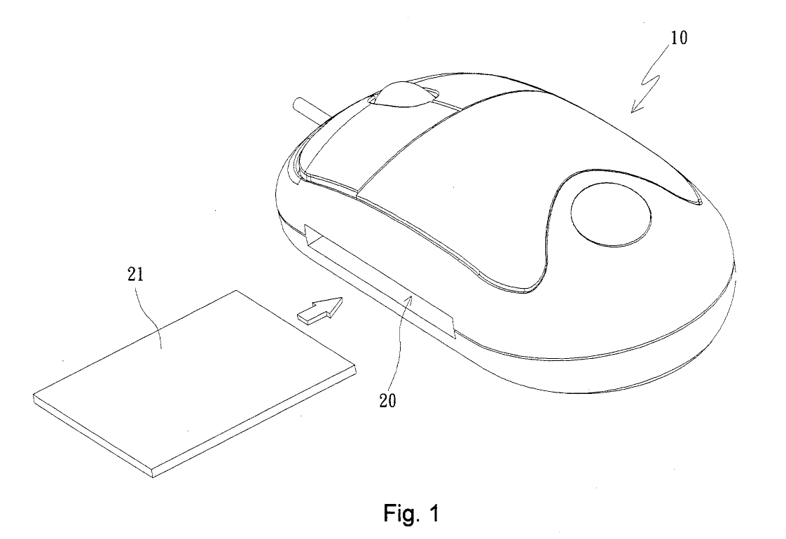

Please refer to FIG. 1. The inventive indexer structure combined with a card-reading device is made by combining an indexer 10 and a card-reading device 20 so as to form a unity device. Therefore, the two independent structures originally being operated in a respective way are combined to be a structure where an indexer 10 is provided with a card-reading device 20 at an appropriate position. Then, a card 21 (such as a IC card, a memory card, a driving control card, an identification card) is inserted in a contact mode so as to perform the functions of accessing the card 21, identification, security shelter or program activation. Thus, the structure is designed to have not only the functions of the indexer 10 but also those of the card-reading device 20. This omni-functional structure can be employed in different applications and promote the convenience of usage.

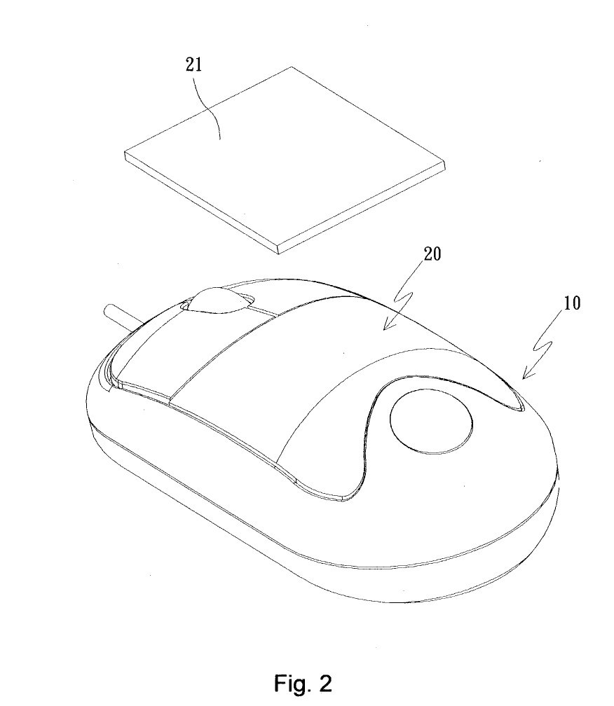

Please refer to FIG. 2. FIG. 2 shows another embodiment of the indexer structure combined with a card-reading device according to the present invention. The indexer 10 is provided with a card-reading device 20 at an appropriate position. Then, a card 21 (such as a IC card, a memory card, a driving control card, an identification card) is closely induced in a non-contact mode so as to perform the functions of accessing the card 21, identification, security shelter or program activation. Thus, the structure is designed to have not only the functions of the indexer 10 but also those of the card-reading device 20. This omni-functional structure can be employed in different applications and promote the convenience of usage.

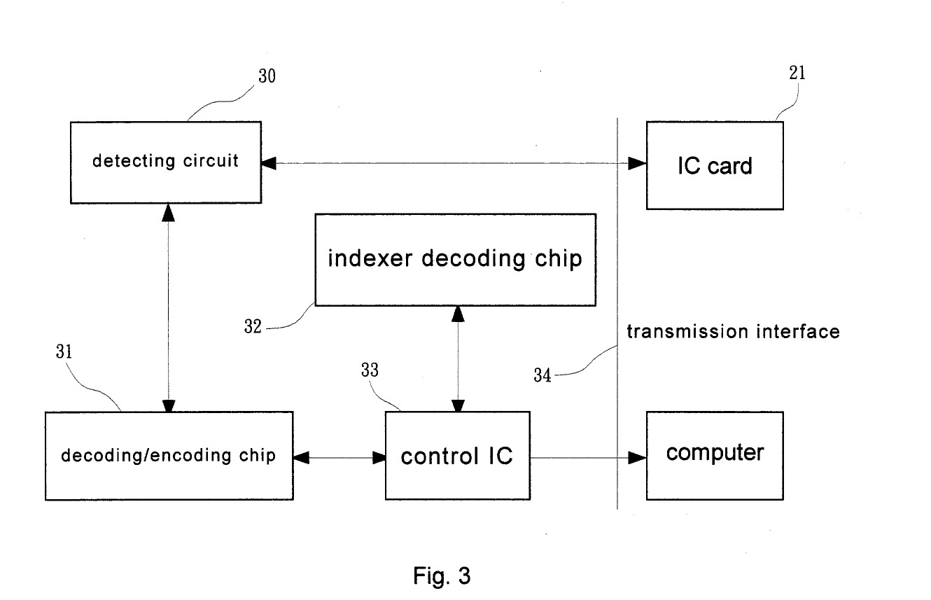

Please refer to FIG. 3. The inventive indexer structure combined with a card-reading device comprises a detecting circuit 30, a decoding/encoding chip 31, an indexer decoding chip 32, a control IC 33 and a transmission interface 34. When the user uses the card-reading device 20, the detecting circuit 30 will perform the functions of data transmission or message receiving during reception for the card 21. When the data of the card 21 is read from or written into the detecting circuit 30, the decoding/encoding chip 31 will process the data and the decoded/encoded data is transmitted to the transmission interface 34 via the control IC 33 controlled by the system so as to communicate with the computer or PDA or another information system platform. When the user uses the indexer 10, by means of inputting execution commands into the indexer 10, the indexer decoding chip 32 will perform the decoding process, and then the control IC 33 will transmit the message to the transmission interface 34 so as to communicate with the computer or PDA or another information system platform. Therefore, the omni-functional structure is designed to have multiple functions.

The detecting circuit can be a detecting antenna circuit or sensing connector, and the transmission interface 34 can be the interface of a USB, PS2 or serial port.

The mentioned indexer 10 can be a mouse, a digital board or a hand-writing input device. The profile of the structure can be varied based on the usage status of the inventive structure.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An indexer structure combined with a card-reading device being an indexer provided with a card-reading device at an appropriate position, and a circuit board being installed in the structure, messages of a card are read by inserting or closely inducing the card in a contact or non-contact mode.

2. An indexer structure combined with a card-reading device being an indexer provided with a card-reading device at an appropriate position, and a circuit board being installed in the structure, messages of a card are read by inserting or closely inducing the card in a contact or non-contact mode, the board comprising:
a detecting circuit for performing the functions of data transmission or message receiving/transmission during reception for the card;
a decoding/encoding chip for executing decoding/encoding process when the data of the card being read from or written into the detecting circuit;
an indexer decoding chip for inputting commands to indexer so as to execute the decoding/encoding process;
a control IC for transmitting the decoded/encoded data to the transmission interface; and
a transmission interface for communicating with a computer or PDA or another computer information system platform.

3. The indexer structure combined with a card-reading device according to claim 1, wherein the card can be an IC card, a memory card, a driving control card or a user identification card.

4. The indexer structure combined with a card-reading device according to claim 2, wherein the card can be an IC card, a memory card, a driving control card or a user identification card.

5. The indexer structure combined with a card-reading device according to claim 2, wherein the detecting circuit can be a detecting antenna circuit or sensing connector.

6. The indexer structure combined with a card-reading device according to claim 2, wherein the transmission interface can be the interface of a USB, PS2 or serial port.

7. The indexer structure combined with a card-reading device according to claim 1, wherein the indexer can be a mouse, a digital board or a hand-writing input device.

8. The indexer structure combined with a card-reading device according to claim 2, wherein the indexer can be a mouse, a digital board or a hand-writing input device.
